(19) United States
(12) Patent Application Publication
(10) Pub. No.: US 2017/0059383 A1
(43) Pub. Date: Mar. 2, 2017

(54) Liquid Measuring and Dispensing Container

(71) Applicant: SONOCO DEVELOPMENT, INC, Hartsville, SC (US)

(72) Inventor: Paul Melia, Saint Petersburg, FL (US)

(21) Appl. No.: 14/841,066

(22) Filed: Aug. 31, 2015

(51) Int. Cl. G01F 11/26; G01F 11/28

(52) U.S. Cl. CPC G01F 11/262; G01F 11/288

(57) ABSTRACT

A dual chambered dispensing bottle that utilizes gravity and bottle geometry to precisely dose a desired amount of a liquid.

### BACKGROUND OF THE INVENTION

Field of the Invention

This disclosure relates to a dual chambered dispensing bottle that utilizes gravity and bottle geometry to precisely dose the desired amount of a liquid, such as an additive or concentrate. The bottle eliminates the need for a double neck and a secondary cap or valve to separate the main (reservoir) chamber from the dispensing chamber, reducing overall packaging costs.

Description of the Related Art

The current pharmaceutical, marine, agricultural, and automotive markets offer a number of dispensing containers for medicines, additives and the like. Typically automotive additives are dispensed using a view stripe to help gauge the amount of additive being used. This has proven to be very inaccurate and can be costly if the more expensive additives are not precisely measured and dispensed. The present disclosure addresses this need.

### BRIEF SUMMARY OF THE INVENTION

The present disclosure relates to a bottle for dispensing a premeasured amount of liquid. The bottle may comprise a body, a neck extending upwardly from the body and a transfer tube.

The body defines a main chamber and a dispensing chamber located above the main chamber. The main chamber and the dispensing chamber are separated by an internal wall. The internal wall comprises a bottom wall and a spill wall extending upwardly at an angle from the bottom wall and terminating in a spill edge. The spill edge limits the amount of liquid that can be held in the dispensing chamber.

The body further comprises a bottom and sidewalls extending upwardly from the bottom. The internal wall, the bottom and a lower portion of the sidewalls define the main chamber. An upper portion of the sidewalls and the internal wall define the dispensing chamber. The lower portion of the sidewalls should be of a construction and material that allows them to be squeezed inwardly.

The transfer tube defines a passageway between the main chamber and the dispensing chamber, and has a lower opening communicating with the main chamber near the bottom and an upper opening communicating with the dispensing chamber.

The present disclosure also relates to a method of filling a bottle, comprising the steps of: filling the dispensing chamber with liquid via a fill tube; and transferring the liquid from the dispensing chamber to the main chamber by tilting the bottle in the direction of the transfer tube so that liquid cascades over the spill edge and flows down through the passageway into the main chamber.

The present disclosure also relates to a method of dispensing liquid from a bottle, the method comprising the steps of: squeezing the sidewalls around the main chamber to force liquid up through the passageway, over the spill edge and into the dispensing chamber until a desired amount of liquid resides in the dispensing chamber; tilting the bottle in a direction away from the transfer tube so that the liquid in the dispensing chamber moves away from the transfer tube and toward the neck while any liquid in the transfer tube flows downwardly into the main chamber; and further tilting the bottle to dispense the liquid in the dispensing chamber while any liquid in the main chamber remains in the main chamber.

### BRIEF DESCRIPTION OF THE DRAWINGS

FIG. 1 is a perspective view of a measuring and dispensing bottle according to the disclosure.

FIGS. 2 and 3 are perspective views of a measuring and dispensing bottle being filled.

FIGS. 4-6 are views of the bottle of FIG. 1 as liquid is being transferred into the dispensing chamber prior to dispensing.

FIGS. 7-10 are views of the bottle of FIG. 1 as liquid is being dispensed from the dispensing chamber.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

This disclosure may use relative terms such as “above”, “below”, “horizontal”, “laterally”, “upwardly” and “downwardly.” These terms generally may be interpreted to refer to a direction or orientation with respect to the pull of gravity, as applied to a bottle in its upright position, where “upwardly”, for example, means in a direction against the pull of gravity, and “laterally” means in a direction substantially perpendicular to the pull of gravity, or what may conventionally be referred to as “sideways.”

This disclosure relates to a dual chambered dispensing bottle that utilizes gravity and bottle geometry to precisely dose the desired amount of a liquid, such as an additive or concentrate. The bottle eliminates the need for a double neck and a secondary cap or valve to separate the two chambers, reducing overall packaging costs.

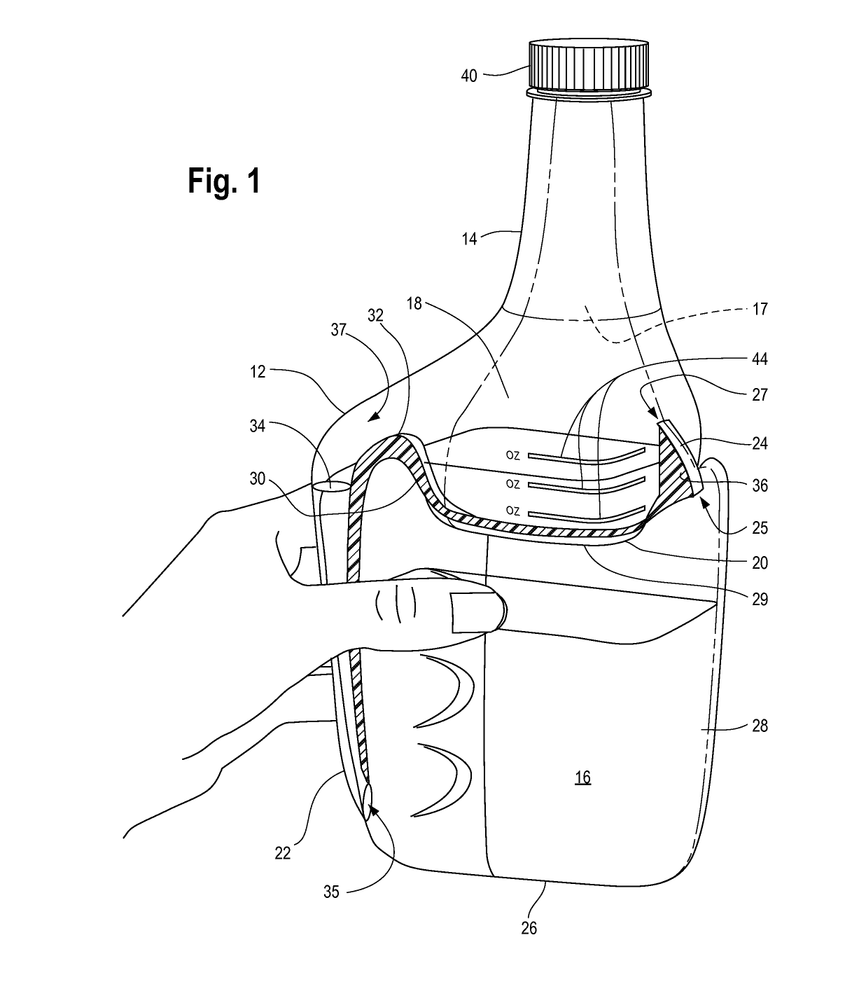

Turning to the drawings, there is shown in FIG. 1 one embodiment of the present invention, a measuring and dispensing bottle 10. The bottle 10 comprises a body 12 and a neck 14.

The body 12 has a lower main chamber 16 and an upper dispensing chamber 18 separated by an internal wall 20. The internal wall 20 may comprise a substantially horizontal (i.e., perpendicular to the pull of gravity when the bottle is at rest) bottom wall 29 and a spill wall 30 extending upwardly at an angle from the bottom wall 29 and terminating in a spill edge 32. The included angle defined by the bottom wall 29 and the spill wall 30 may be greater than 90 degrees and preferably about 125 degrees.

The body 12 may comprise a bottom 26 and sidewalls 28 extending upwardly from the bottom 26. Together with the internal wall 20, the bottom 26 and a lower portion of the sidewalls 28 define the main chamber 16. An upper portion of the sidewalls 28 and the internal wall 20 define the dispensing chamber 18 located above the main chamber 16. The lower portion of the sidewalls 28 should be of a construction and material that allows the lower portion of the sidewalls 28 to be squeezed inwardly.

A transfer tube 22 defines a passageway 34 between the main chamber 16 and the dispensing chamber 18. The transfer tube 22 has two openings. A lower opening 35 communicates with the main chamber 16 and preferably the bottom of the main chamber 16. An upper opening 37 communicates with the dispensing chamber 18 and preferably an area of the dispensing chamber 18 just above the spill edge 32.

The neck 14 extends upwardly from the body 12 above the dispensing chamber 18, and preferably above a portion of the body 12 laterally opposite the transfer tube 22. The neck defines a neck space 17. The neck 14 may terminate in a threaded portion 15 configured to receive a threaded cap 40.

A vent tube 24 defines a passageway 36 between the main chamber 16 and the neck 14 that can be used to vent air during the filling process as explained below. The vent tube 24 defines a lower opening 25 that communicates with the main chamber 16 and preferably a portion of the main chamber 16 above the internal wall 20 (and thus above the fill line 19) and an upper opening 27 that communicates with the dispensing chamber 18 or the neck space 17, preferably at a location above the top (maximum) achievable level 21 of liquid inside the dispensing chamber 18. Preferably the vent tube 24 is located on a side of the bottle 10 laterally opposite the transfer tube 22 and the spill wall 30.

### Filling

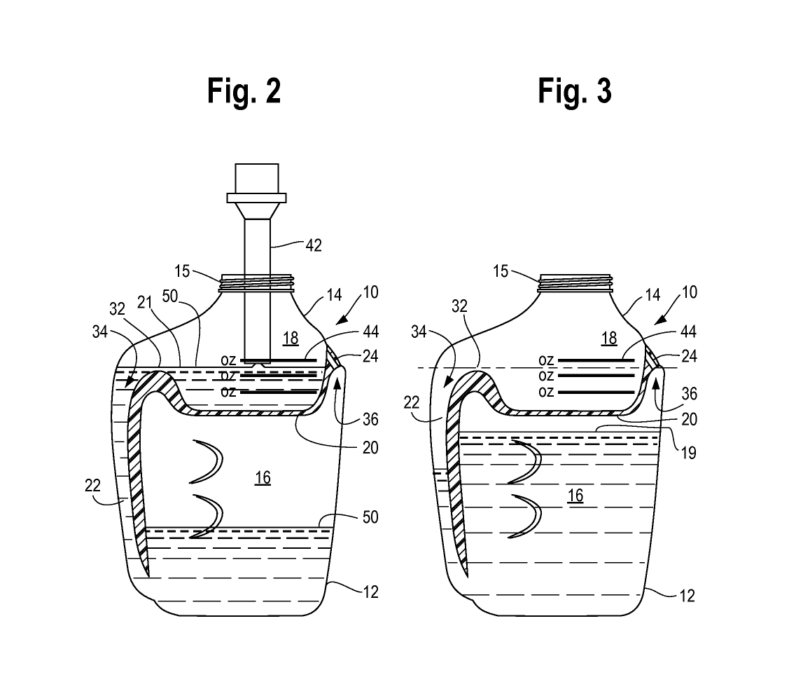

FIGS. 2 and 3 show one way in which the bottle 10 may be filled. During initial filling, liquid 50 begins to fill the dispensing chamber 18 via a fill tube 42. The liquid 50 is transferred from the dispensing chamber 18 to the main chamber 16 by cascading over the spill edge 32 and flowing down through the passageway 34 into the main chamber 16. As the main chamber 16 fills with liquid 50, air is displaced and exhausted through the vent tube 24. Tilting the bottle 10 in the direction of the transfer tube 26 will transfer any liquid 50 remaining in the dispensing chamber 18 into the main chamber 16. The included angle defined by the spill wall 30 and the substantially horizontal internal wall 20 should be larger than 90 degrees to allow the main chamber 16 to be filled with as large a volume of liquid 50 as possible while maintaining the integrity of the dispensing chamber 18.

The main chamber 16 may be filled up to a fill line 19 located at or just below the internal wall 20. After filling is complete, the vent passageway 36 may be closed using a weld or other means so that the only means of transferring liquid 50 between the two chambers is via the transfer tube passageway 34.

Alternatively, the main chamber 16 may be filled through an orifice located in the internal wall 20 (not shown) which is then sealed off. During filling, displaced air in the main chamber 16 exits through the vent tube 24, which again can be sealed off after filling is complete.

### Dispensing

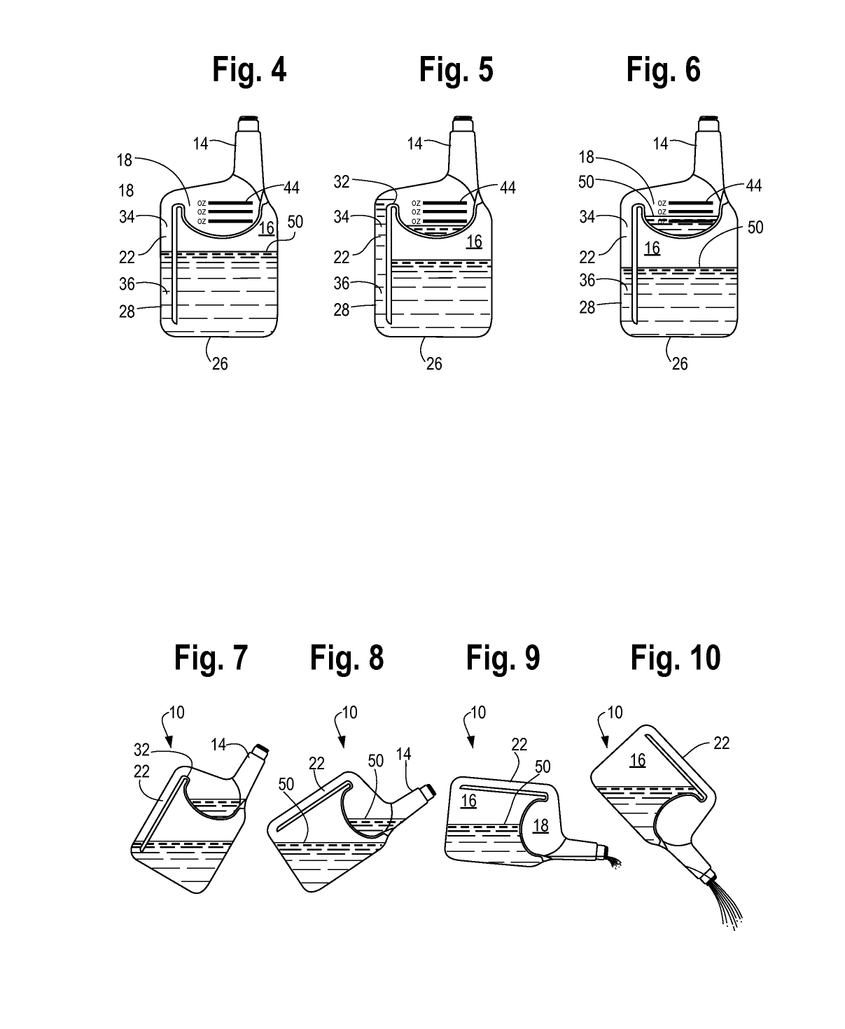

FIGS. 4 through 10 illustrate how the bottle 10 may be used to dispense a measured amount of liquid 50.

FIG. 4 shows the bottle 10 at rest, before being used. The liquid 50 typically will be located only in the main chamber 16.

In FIG. 5 the sidewalls 28 around the main chamber 16 are being squeezed inwardly, such as by a person (not shown). As the sidewalls 28 are squeezed, some liquid 50 is forced up through the transfer tube 22, over the spill edge 32 and into the dispensing chamber 18. The person may continue squeezing the sidewalls 28 until a desired amount of liquid 50 resides in the dispensing chamber 18. The spill edge 32 limits the amount of liquid 50 that can be held in the dispensing chamber 18 while the bottle 10 is at rest.

Preferably squeezing results in the inward movement of the lower portion of the sidewalls 28 (defining the main chamber) but not the upper portion of the sidewalls 28 (defining the dispensing chamber), so that the volume of the dispensing chamber 18 remains substantially constant. In this way a desired amount of liquid 50 may be transferred to the dispensing chamber 18 by filling the dispensing chamber 18 to the desired liquid level 21 using the molded calibrations 44.

FIG. 6 shows the bottle 10 after being squeezed and after the sidewalls 28 have returned to their normal (unsqueezed) position. A desired amount of liquid 50 is now located in the dispensing chamber 18. The volume of liquid 50 in the dispensing chamber 18 is indicated by the molded calibrations 44 on the sidewalls 28 around the dispensing chamber 18. The dispensing chamber 18 may be calibrated in any suitable units, such as (fl. oz./ml). The liquid 50 in the dispensing chamber 18 is now ready for dispensing by simply tiling the bottle 10.

FIG. 7 shows the bottle 10 as it is being tilted (tipped) in a direction away from the transfer tube 22. The liquid 50 in the dispensing chamber 18 moves away from the transfer tube 22 and toward the neck 14. Any liquid in the transfer tube 22 flows downwardly into the main chamber 16

FIG. 8 shows the bottle 10 tilted until the main chamber liquid 50 (and the dispensing chamber liquid 50) is now fully isolated from the fill tube 22 and below the spill edge 32. The liquid 50 that was in the transfer tube 22 when the bottle 10 was at rest (FIG. 6) is now in the main chamber 16. The liquid 50 in the dispensing chamber 18 can now be dispensed (poured out) by further tilting of the bottle 10.

FIG. 9 shows the bottle 10 tilted even further so that the main chamber liquid 50 is separated from the dispensing liquid 50, and the dispensing liquid 50 is being dispensed (poured) from the dispensing chamber 18.

FIG. 10 shows the bottle 10 almost fully inverted for full dispensing liquid evacuation. The remaining (undispensed) liquid 50 remains in the main chamber 16. Even complete inversion of the bottle 10 will not result in any liquid being dispensed from the main chamber 16, since at full inversion the liquid level in the main chamber will be below the transfer tube lower opening 35.

### INDUSTRIAL APPLICABILITY

The bottle may have a short neck or a conventional “long neck” design allowing a user to pour the desired amount of product into the fill point of an automobile, watercraft, or other vehicle that requires a dispensed product into the gas tank fill location, including the newer capless vehicles, such as those manufactured by Ford Motor Company. The bottle can also be used in the lawn and garden industry in the precise dispensing of lawn chemical concentrates, for weeds, feed, and insect control.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A bottle for dispensing a liquid, the bottle comprising:
a body defining a main chamber and a dispensing chamber located above the main chamber, the main chamber and the dispensing chamber being separated by an internal wall, the internal wall comprising a bottom wall and a spill wall extending upwardly at an angle from the bottom wall and terminating in a spill edge, the spill edge limiting the amount of liquid that can be held in the dispensing chamber while the bottle is at rest, the body comprising a bottom and sidewalls extending upwardly from the bottom, the internal wall, the bottom and a lower portion of the sidewalls defining the main chamber, an upper portion of the sidewalls and the internal wall defining the dispensing chamber, the lower portion of the sidewalls being of a construction and material that allows the lower portion of the sidewalls to be squeezed inwardly;
a neck extending upwardly from the body above the dispensing chamber; and
a transfer tube defining a passageway between the main chamber and the dispensing chamber, the transfer tube defining a lower opening communicating with the main chamber near the bottom and an upper opening communicating with the dispensing chamber and partially defined by the spill edge.

2. The bottle of claim 1 wherein the neck extends above a portion of the body laterally opposite the transfer tube.

3. The bottle of claim 1 further comprising a vent tube defining a passageway between the main chamber and the bottle neck.

4. The bottle of claim 3 wherein the vent tube defines a lower opening communicating with a portion of the main chamber above the internal wall and an upper opening communicating with the dispensing chamber.

5. The bottle of claim 1 wherein the neck terminates in a threaded portion configured to receive a threaded cap.

6. A method of filling the bottle of claim 2 comprising the steps of:
filling the dispensing chamber with liquid via a fill tube;
transferring the liquid from the dispensing chamber to the main chamber by tilting the bottle in the direction of the transfer tube so that liquid cascades over the spill edge and flows down through the passageway into the main chamber.

7. The method of claim 6 wherein, during the transferring step air is displaced from the main chamber and exhausted through a vent tube.

8. The method of claim 6 comprising the further step of:
closing the vent passageway after the filling step.

9. A method of dispensing liquid from the bottle of claim 2, the method comprising the steps of:
squeezing the sidewalls around the main chamber to force liquid up through the passageway, over the spill edge and into the dispensing chamber until a desired amount of liquid resides in the dispensing chamber;
tilting the bottle in a direction away from the transfer tube so that the liquid in the dispensing chamber moves away from the transfer tube and toward the neck while any liquid in the transfer tube flows downwardly into the main chamber; and
further tilting the bottle to dispense the liquid in the dispensing chamber while any liquid in the main chamber remains in the main chamber.

10. The method of claim 9 wherein the further tilting step includes tilting the bottle until it is fully inverted.
